(19) United States
(12) Patent Application Publication
(10) Pub. No.: US 2025/0284961 A1
(43) Pub. Date: Sep. 11, 2025

(54) SYSTEM AND METHOD FOR HARDWARE-AWARE JOINT OPTIMIZATION OF MACHINE LEARNING MODEL ARCHITECTURE AND QUANTIZATION

(71) Applicant: Synaptics Incorporated, San Jose, CA (US)

(72) Inventors: Brendan Reidy, San Jose, CA (US); Karthikeyan Shanmuga Vadivel, San Jose, CA (US); Zacchaeus Scheffer, San Jose, CA (US); Deepak Mital, Fremont, CA (US)

(73) Assignee: Synaptics Incorporated, San Jose, CA (US)

(21) Appl. No.: 19/070,278

(22) Filed: Mar. 4, 2025

Related U.S. Application Data
(60) Provisional application No. 63/562,989, filed on Mar. 8, 2024.

(51) Int. Cl. G06N 3/086; G06N 3/0464; G06N 3/0495

(52) U.S. Cl. CPC G06N 3/086; G06N 3/0464; G06N 3/0495

(57) ABSTRACT

Methods and apparatus are disclosed for joint optimization of machine learning model architecture and quantization. An example method includes generating a first machine learning model for a resource-constrained device based on quantized outputs from each of a plurality of compute blocks. Each compute block includes a plurality of inverted residual blocks coupled in series. Determining the quantized output of each respective compute block includes performing a first convolution, based at least in part on a first quantization level, on input data to a first inverted residual block, performing a second convolution on an output of the first convolution based at least in part on the first quantization level, adding an output of the second convolution to the input data to generate a first quantized output, and providing the first quantized output to a second inverted residual block, and providing the first machine learning model to the resource-constrained device for execution.

### CROSS-REFERENCE TO RELATED APPLICATIONS

This application claims the benefit of U.S. Provisional Application No. 63/562,989, entitled “System and Method for Hardware-Aware Joint Optimization of Machine Learning Model Architecture and Quantization,” filed on Mar. 8, 2024, which is incorporated by reference herein in its entirety.

### BACKGROUND

Neural network (NN) models for embedded applications can be designed in two stages. In the first stage, the model architecture is chosen using an available backbone or by Neural Architecture Search (NAS). In the second stage, the model is trained and finally quantized before deployment. The quantization can use a fixed bit width (e.g., 8-bit). Designing the NN architecture and optimizing quantization in two disconnected stages is a limitation of current NN workflows.

### SUMMARY

The present invention is directed to a system and method for hardware-aware joint optimization of machine learning model architecture and quantization (also referred to as the Memory-Constrained Mixed-Precision NAS or MCMP-NAS). Given latency and memory constraints (e.g., weight memory and activation memory), embodiments of the present invention can identify a mixed-precision model from a family of model architectures that achieves the best performance on a given dataset. According to the present invention, MCMP-NAS jointly aims to identify the optimal machine learning model architecture and the quantization precision for each layer under memory constraints of a given resource-constrained target hardware. In other words, MCMP-NAS can use an appropriate framework to jointly optimize the machine learning model architecture and quantization precision (for each layer) for a given resource-constrained target hardware. The hardware-aware NAS system and method of the present invention can jointly search for machine learning model architecture along with quantization levels for each layer in the network. Some implementations of the present invention can use a Once-For-All (OFA) hardware aware NAS framework. Machine learning models identified using the present invention can achieve significantly lower latency for comparable performance as state-of-the-art models on resource-constrained target hardware. Additionally, the mixed precision NAS models according to embodiments of the present invention can achieve better performance as NAS optimized 8-bit and 4-bit quantized models with considerably lower model size requirement. Embodiments of the present invention can automate the search for neural network (NN) architectures and mixed-precision quantization within a single framework.

One innovative aspect of the present disclosure can be implemented as a method for hardware-aware joint optimization of machine learning model architecture and quantization. An example method includes generating a first machine learning model for a resource-constrained hardware device based on a combination of quantized outputs from each of a plurality of compute blocks, each compute block including a plurality of inverted residual blocks coupled in series for determining the quantized output of each respective compute block. Determining the quantized output of each respective compute block may include performing a first convolution on input data to a first inverted residual block of the plurality of inverted residual blocks, the first convolution based at least in part on a first quantization level corresponding to the first inverted residual block, performing a second convolution on an output of the first convolution based at least in part on the first quantization level, adding an output of the second convolution to the input data to generate a first quantized output of the first inverted residual block, and providing the first quantized output of the first inverted residual block to a second inverted residual block of the plurality of inverted residual blocks. The first machine learning model is then provided to the resource-constrained hardware device for execution.

In some aspects, the first machine learning model includes a once-for-all (OFA) neural network generated based at least in part on a progressive shrinking algorithm, the OFA neural network including a plurality of sub-networks.

In some aspects, the plurality of inverted residual blocks includes a first number of inverted residual blocks, the first number selected based at least in part on an evolutionary algorithm configured to select a best performing sub-network of the plurality of sub-networks based at least in part on a constraint associated with the resource-constrained hardware device. In some aspects, the evolutionary algorithm is configured to select the best performing sub-network of the plurality of sub-networks based at least in part on one or more second machine learning models trained to predict performance of sub-networks of the plurality of sub-networks. In some aspects, the one or more second machine learning models are configured to predict an accuracy and a latency associated with one or more sub-networks of the plurality of sub-networks.

In some aspects, a kernel size associated with the first convolution and the second convolution is selected based at least in part on an evolutionary algorithm configured to select a best performing sub-network of the plurality of sub-networks based at least in part on a constraint associated with the resource-constrained hardware device.

In some aspects, a first channel expansion factor associated with the first inverted residual block is selected based at least in part on an evolutionary algorithm configured to select a best performing sub-network of the plurality of sub-networks based at least in part on a constraint associated with the resource-constrained hardware device.

In some aspects, an input resolution associated with the input data is selected based at least in part on an evolutionary algorithm configured to select a best performing sub-network of the plurality of sub-networks based at least in part on a constraint associated with the resource-constrained hardware device.

In some aspects, the first quantization level is selected based at least in part on one or more constraints associated with the resource-constrained hardware device, the one or more constraints including one or more of a latency constraint and a memory usage constraint.

In some aspects, the first convolution includes a first convolution and rectified linear operation based on the first quantization level.

In some aspects, determining the quantized output of each respective compute block further includes receiving the first quantized output as an input to the second inverted residual block, performing a third convolution on the first quantized output, the third convolution based at least in part on a second quantization level corresponding to the second inverted residual block, performing a fourth convolution on an output of the third convolution based at least in part on the second quantization level, adding an output of the fourth convolution to the first quantized output to generate a second quantized output of the second inverted residual block, and providing the second quantized output of the second inverted residual block to a third inverted residual block of the plurality of inverted residual blocks. In some aspects, the second quantization level is different from the first quantization level.

In some aspects, the plurality of compute blocks include at least a first compute block associated with the first quantization level and a second compute block associated with a second quantization level different from the first quantization level.

### BRIEF DESCRIPTION OF THE DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a block diagram illustrating an example system for hardware-aware joint optimization of machine learning model architecture and quantization;

FIGS. 2A and 2B are graphs illustrating performance results of Memory-Constrained Mixed-Precision Neural Architecture Search (MCMP-NAS) for CIFAR-10 image classification;

FIGS. 3A and 3B are graphs illustrating performance results of MCMP-NAS for COCO object detection;

FIG. 4A is a graph illustrating the latency profiles on resource-constrained target hardware for various randomly sampled object detection model architectures in the present NAS space;

FIG. 4B is a graph illustrating the high accuracy of the latency predictor that was used to predict the MCMP-NAS latency on the resource-constrained target hardware;

FIG. 5 is a flowchart of an example method for hardware-aware joint optimization of machine learning model architecture and quantization;

FIG. 6 is a flowchart of an example method for determining the quantized output of each respective compute block;

FIG. 7 is a block diagram of an example computing device that may perform one or more of the operations described herein, in accordance with the present embodiments; and

FIG. 8 is a flowchart of an example method for hardware-aware joint optimization of machine learning model architecture and quantization, in accordance with some implementations.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Deep neural networks deliver state-of-the-art accuracy for most machine learning (ML) applications. However, efficiently deploying these models in resource constrained devices (e.g., Internet of Things (IoT) devices and the like) is a challenging task. Conventional open-source models are optimized for inference on GPUs. These architectures may not be best suited for inference on resource constrained devices. Such an observation has led to the creation of several Hardware-aware Neural Architecture Search (NAS) approaches. These approaches aim to find the optimal model architecture within a family of models that is most efficient (latency versus accuracy) for inference on given hardware.

For IoT devices, one of the major factors that makes it challenging to design a robust machine learning model is the significant limitation in the amount of memory available for model storage and inference. Conventional approaches do not factor in memory limitations during the neural architecture search pipeline. Additionally, the NAS model weights and activations are eventually quantized from floating-point to lower precision (e.g., 8-bit or 16-bit) before deployment. One strategy is to obtain the trained NAS model and separately quantize it to lower precision. There are also approaches that aim to identify the ideal quantization precision for different layers in the neural network, but this does not address the limitation of optimizing the machine learning model architecture and quantization in disconnected stages.

A strategy for choosing machine learning model architectures is to use conventional state-of-the-art open source model backbones, such as, for example, Yolov5, Yolov8, or the like. Such backbones are, however, usually optimized for GPUs and may not achieve the best performance on resource-constrained hardware. Such models also have performance degradation at levels of sub-8-bit precision, and identifying the quantization precision for each layer for these models is a non-trivial task. Embodiments of the present invention can overcome such limitations by identifying the architecture and quantization levels for each layer jointly optimized for the target resource-constrained hardware. The present invention can also achieve much better performance than conventional, state-of-the-art models.

The present invention is directed to a system and method for hardware-aware joint optimization of machine learning model architecture and quantization (also referred to as the Memory-Constrained Mixed-Precision NAS or MCMP-NAS). Given latency and memory constraints (e.g., weight memory and activation memory), embodiments of the present invention can identify a mixed-precision model from a family of machine learning model architectures that achieves the best performance on a given dataset (e.g., accuracy for classification, mAP for object detection, etc.). According to the present invention, MCMP-NAS jointly aims to identify the optimal machine learning model architecture and the quantization precision for each layer under memory constraints of a given resource-constrained target hardware (e.g., a system-on-chip (SOC) or the like). In other words, MCMP-NAS can use an appropriate framework to jointly optimize the machine learning model architecture and quantization precision (for each layer) for a given resource-constrained target hardware. The hardware-aware NAS system and method of the present invention can jointly search for model architecture along with quantization levels for each layer in the network. Some implementations of the present invention can use a Once-For-All (OFA) hardware aware NAS framework. Machine learning models identified using the present invention can achieve significantly lower latency for comparable performance as state-of-the-art models on resource-constrained target hardware. Additionally, the mixed precision NAS models according to embodiments of the present invention can achieve better performance as NAS optimized 8-bit and 4-bit quantized models with considerably lower model size requirement. Embodiments of the present invention can automate the search for neural network (NN) architectures and mixed-precision quantization within a single framework.

For purposes of illustration and not limitation, in some implementations of the present invention, MCMP-NAS can use an OFA NAS approach, although other suitable NAS approaches are possible. The OFA approach aims to optimize the machine model architecture parameters, such as kernel sizes and widths of each convolutional layer, model depth and input resolution, to the machine learning model given a latency constraint while running on specific hardware. The OFA approach achieves this by the following pipeline: (i) train a single OFA network to support versatile architecture configurations such as depth, width, kernel size and resolutions using a progressive shrinking algorithm; (ii) sample sub-network from OFA network and train models to predict accuracy and latency of the sub-networks; and (iii) given a latency constraint, utilize an evolutionary algorithm to search for the best performing sub-networks using the trained accuracy and memory predictors.

MCMP-NAS can incorporate mixed-precision quantization into the OFA SuperNet (Once-For-All network) training. MCMP-NAS can also simplify the accuracy predictor used in OFA evolutionary search that improves the search results. Finally, to address the issue of adding memory constraints, MCMP-NAS can efficiently estimate the memory usage of a machine learning model that includes tensor arena and model weights size and can incorporate it into OFA evolutionary search.

The primary challenge in designing NN models in TinyML space is fitting the machine learning model within the available memory budget of the SOC or other resource-constrained target device. To achieve this, MCMP-NAS model architecture optimization and quantization both play an important role in reducing the machine learning model size. Therefore, embodiments of the present invention can address the problem of jointly determining these parameters given a memory constraint.

Due to its efficiency, some implementations of the present invention can use OFA as the foundation NAS technique, although other suitable NAS techniques are possible. In addition to the architecture search, MCMP-NAS can identify the ideal mixed-precision quantization setting for weights of each layer. In some embodiments, the mixed-precision optimization can be restricted to convolution layers, as the majority of computations in CNNs are convolutions. Merely for purposes of discussion and not limitation, in the present disclosure the activations can be 8-bit quantized, although other quantization levels are possible.

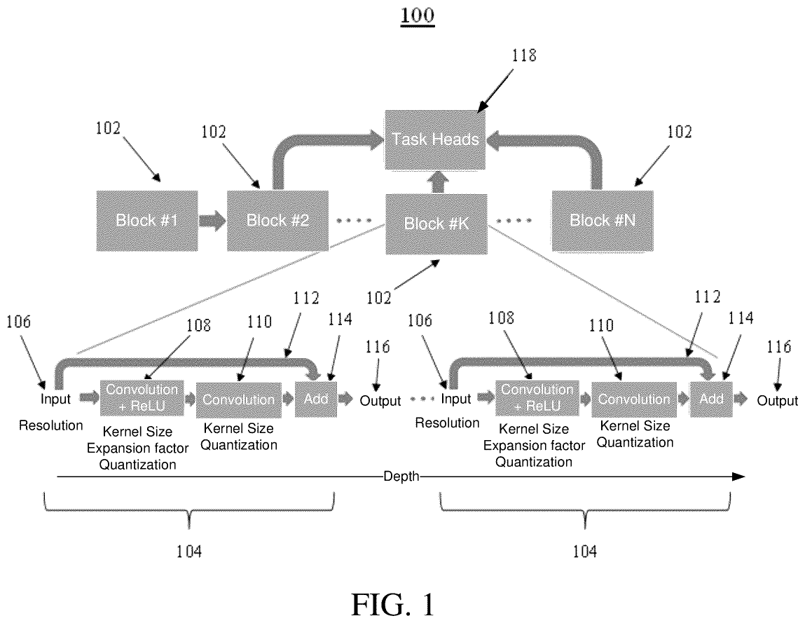

FIG. 1 is a block diagram illustrating an example system 100 for hardware-aware joint optimization of machine learning model architecture and quantization. The backbone of system 100 includes a plurality of compute blocks 102 (Bk) coupled in series. In embodiments, each compute block 102 can be designed as a variant of an inverted residual block or the like, as discussed in more detail below. Any suitable number of such compute blocks 102 can be used in the system 100. In some implementations of the present invention, the depth-wise and pointwise convolutions can be merged in inverted residual blocks into a full convolution, which are more efficient on resource-constrained target hardware. In embodiments, the input resolution, kernel size, channel expansion factor, and quantization level for each convolution performed in the system 100 can be the parameters that can be optimized using MCMP-NAS. It is noted that the total number of possible architectures for the MCMP-NAS model space of the present invention can be enormous, such as 1.2×10²⁹ in some implementations, which is intractable to search without a NAS approach. Therefore, merely for purposes of illustration but not limitation, embodiments of the present invention can use OFA, although other suitable NAS approaches can be used.

An inverted residual block is a type of residual block used for, for example, image models that follows an inverted structure for efficiency purposes. For example, the inverted residual block can follow a narrow→wide→narrow approach. In such an approach, a 1×1 convolution can be performed to narrow the input channel. Then, a 3×3 depthwise convolution can be performed, which can reduce the number of parameters, thereby making the model faster and more efficient. Finally, another 1×1 convolution can be performed to increase the number of channels to match the input so that the input and output can be added. Such an approach has several advantages over the conventional residual block structure. First, it is more efficient, because it requires fewer parameters for computation, which makes it faster and more accurate. Additionally, the inverted structure can be used for maintaining high accuracy in models while keeping model size and computational requirements low, particularly in devices with limited processing and memory resources.

Conventional OFA implementations do not consider memory required for the machine learning model. In some implementations of the present invention, various modifications and enhancements can be made to OFA to achieve the goal of jointly determining architecture and quantization parameters under memory constraints. First, during the OFA model training, mixed-precision quantization can be added to the final stage of the progressive shrinking (PS) algorithm. In some implementations of the present invention, the bit-precision for each convolution layer can be either 4, 6 and 8 bits, while activations can be maintained at 8-bits precision or the like. However, other quantization levels are possible. Such a step enables quantization aware training in conjunction with varying machine learning model architecture. Accordingly, embodiments of the present invention can support sampling sub-networks that have different model architectures and quantization parameters. Next, the evolutionary algorithm used in OFA can be appropriately modified to jointly search for machine learning model architecture and quantization precision. Some implementations of the present invention can also use a suitable internal tool that efficiently computes the memory required for model inference (weights+peak memory during inference). In some embodiments, a memory constraint can also be added into the evolutionary search algorithm. Additionally, it is noted that the performance of the accuracy predictor of OFA is not satisfactory due to a significant increase in the search space due to additional quantization parameters. In some implementations of the present invention, such an issue can be overcome by replacing the accuracy predictor by computing the accuracy on a smaller subset of validation data. Such a modification can significantly improve the efficacy of the evolutionary search algorithm.

Each compute block 102 can be comprised of one or more inverted residual blocks 104 arranged in series. Any suitable number of inverted residual blocks 104 can be used for each or any of the compute blocks 102, where the number of inverted residual blocks 104 used in a compute block 102 can be referred to as the machine learning model “depth.” For each inverted residual block 104, an input 106 is provided to a first convolution and rectified linear unit (ReLU) 108. An ReLU is a piecewise linear function that can output the input directly if it is positive, otherwise it can output a zero. In addition to parameters such as kernel size and expansion factor and the like, a quantization level is also provided to or otherwise used by the first convolution and ReLU 108. The output of the first convolution and ReLU 108 can be provided to the second convolution unit 110. In addition to parameters such as kernel size and the like, the quantization level can also be provided to or otherwise used by the second convolution unit 110. The output of the second convolution 110 and the input 106 (passed via a feedforward line 112) can be added together by adder unit 114. The output 116 of the inverted residual block 104 can be passed to the input 106 of the next inverted residual block 104 in the series. This process can be repeated depending on the number of inverted residual blocks 104 in the compute block 102. In some implementations of the present invention, the quantization level used in a compute block 102 (for each of the inverted residual blocks 104) can be different across different compute blocks 102. Additionally or alternatively, the quantization level in each inverted residual block 104 of a compute block 102 can be different than the quantization level used for other inverted residual blocks 104 in the compute block 102. By incorporating quantization levels directly into each inverted residual block 104 of the overall OFA NAS approach, MCMP-NAS can jointly optimize the machine learning model architecture and quantization precision (for each layer) for a given resource-constrained target hardware. The output 116 of each compute block 102 can be passed to the next successive or subsequent compute block 102 in the plurality of compute blocks 102. Additionally, the output 116 of one or more compute blocks 102 (e.g., the second compute block 102, the third compute block 102, . . . , Nth compute block 102) can be passed to or otherwise sampled by the task heads 118.

Merely for purposes of illustration and not limitation, the improved performance of MCMP-NAS can be illustrated by applying embodiments of the present invention to two conventional computer vision problems-classification and object detection. The MCMP-NAS family of models was benchmarked on CIFAR-10 classification and COCO object detection. On both these tasks, MCMP-NAS achieves much lower latency than conventional state-of-the-art models on resource-constrained hardware at comparable performance. Additionally, mixed-precision NAS models outperform similar sized fixed-precision NAS models (e.g., 8-bit, 4-bit on all layers).

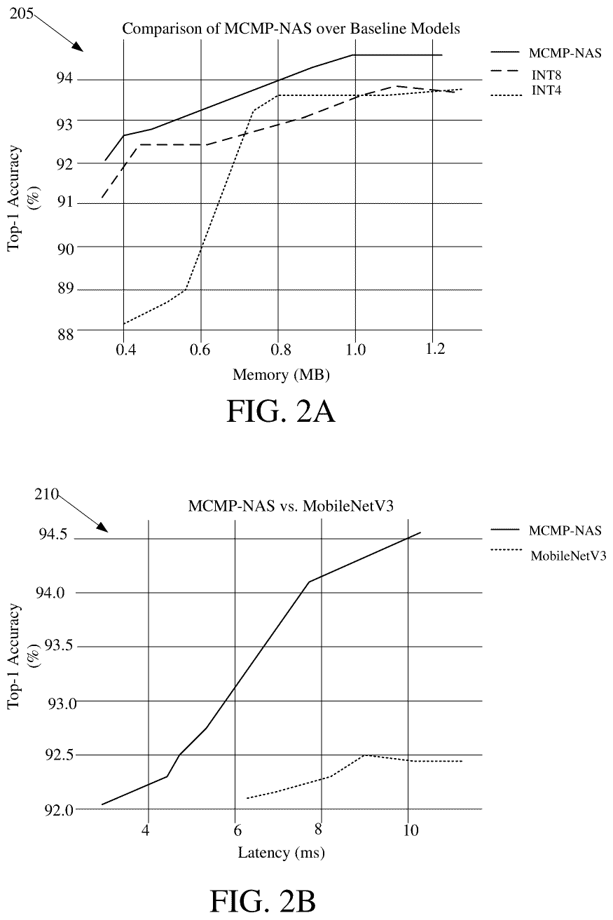

For purposes of the present illustration, a SR110 NPU chip from Synaptics Incorporated can be used as the resource-constrained target hardware, although embodiments of the present invention can work with and be used for any other suitable resource-constrained target hardware. The Synaptics SR110 NPU chip can take advantage of mixed-precision models and has the capability to lower the storage requirements when the weights of the models are quantized to lower bit-widths (e.g., lower than 8-bit). FIGS. 2A and 2B are graphs 205 and 210, respectively, illustrating performance results of MCMP-NAS for CIFAR-10 image classification. The CIFAR-10 dataset comprises 60K images from 10 classes, split into 50K for training and 10K for testing. For purposes of the present illustration, 5K images can be randomly sampled from training (e.g., 500 for each class) for accuracy predictor evaluation in the evolutionary search step. Graph 205 of FIG. 2A illustrates the Top-1 accuracy on CIFAR-10 dataset versus model size for INT8, INT4 and MCMP-NAS models. Graph 205 illustrates that MCMP-NAS machine learning models of the present invention achieve better performance compared to 8-bit and 4-bit NAS models when fixing the model size. Thus, when the input resolution is fixed, graph 205 illustrates that MCMP-NAS has better accuracy compared to 4-bit and 8-bit NAS approaches at comparable model size. Graph 210 of FIG. 2B illustrates the Top-1 accuracy versus latency plotted for the CIFAR-10 dataset on a Synaptics SR110 NPU chip for MCMP-NAS and MobileNetV3 family of models. Graph 210 illustrates that the mixed-precision NAS approach according to embodiments of the present invention outperforms the efficient MobileNet V3 model in latency versus accuracy comparison on the Synaptics SR110 NPU chip, assuming a 3 MB limit for model size and tensor arena (peak activation memory) in the present illustration. In addition, Table 1 is a comparison of the performance of MCMP-NAS with other conventional neural network architectures on the CIFAR-10 classification problem.

TABLE 1
Comparison of the Performance of MCMP-NAS with Other
Conventional Neural Network Architectures.

| Neural network | | Memory |
|---|---|---|
| architecture | Accuracy | requirement (KB) |
| DLA [13] | 95.47% | 15,405 |
| DPN92 [6] | 95.16% | 35,105 |
| PreActResNet18 [9] | 95.11% | 11,368 |
| MobileNetV2 [2] | 94.43% | 2,616 |
| ResNet101 [8] | 93.75% | 43,229 |
| ResNet50 [8] | 93.62% | 24,307 |
| ResNet18 [8] | 93.02% | 11,371 |
| VGG16 [13] | 92.64% | 14,859 |
| MCMP-NAS | 95.72% | 2,553 |
| (Proposed) | | |

Table 1 illustrates that MCMP-NAS outperforms conventional state-of-the-art neural network model architectures with considerably lower memory requirements.

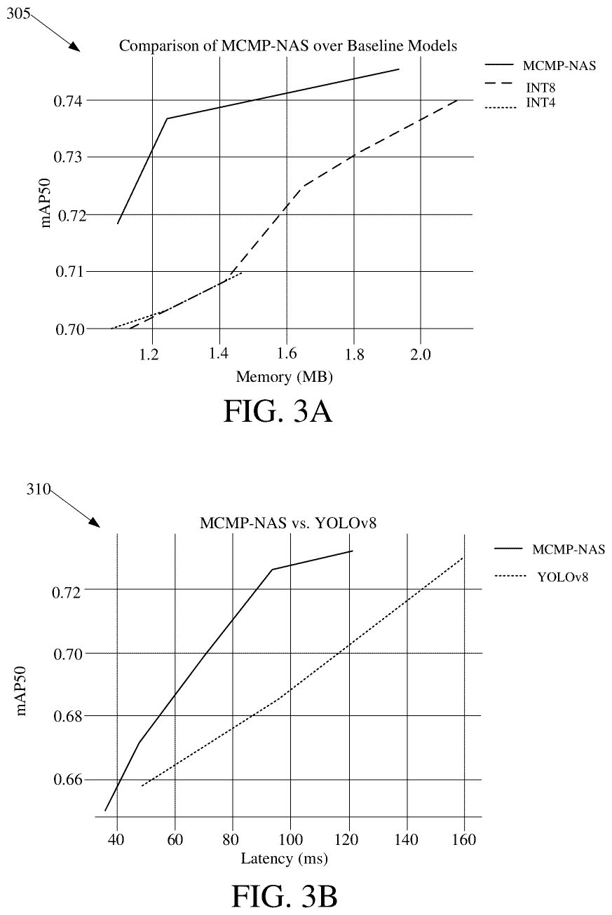

FIGS. 3A and 3B are graphs 305 and 310, respectively, illustrating performance results of MCMP-NAS for COCO object detection. MS COCO 2017 is a conventional dataset for object detection (and several other tasks) with 118K images in training and 5K in test. The original dataset is for 80 classes. However, as the present illustration targets a TinyML application with limited memory, only the person class was considered. Graph 305 of FIG. 3A illustrates mAP-50 on COCO person detection dataset versus model size for INT8, INT4 and mixed-precision NAS models. Graph 305 illustrates that mixed-precision NAS models achieve better performance compared to 8-bit and 4-bit NAS models when fixing the model size. Thus, graph 305 indicates that the MCMP-NAS machine learning models of the present invention outperform the 8-bit and 4-bit NAS models in model size versus accuracy comparison. Graph 310 of FIG. 3B illustrates mAP-50 accuracy on COCO person detection versus latency on the Synaptics SR110 NPU chip for mixed precision and state-of-the-art YOLOV8 model. Graph 310 indicates that the MCMP-NAS of the present invention outperforms the state-of-the-art YOLOV8 family of models (plotted at different input resolutions in graph 310). It is noted that even the YOLOV8 nano model was slightly too large to fit the SRAM memory budget of the Synaptics SR110 NPU chip. The YOLO comparison utilized a model where the hyper-parameters of YOLOV8 nano model were tuned to minimize regression in performance.

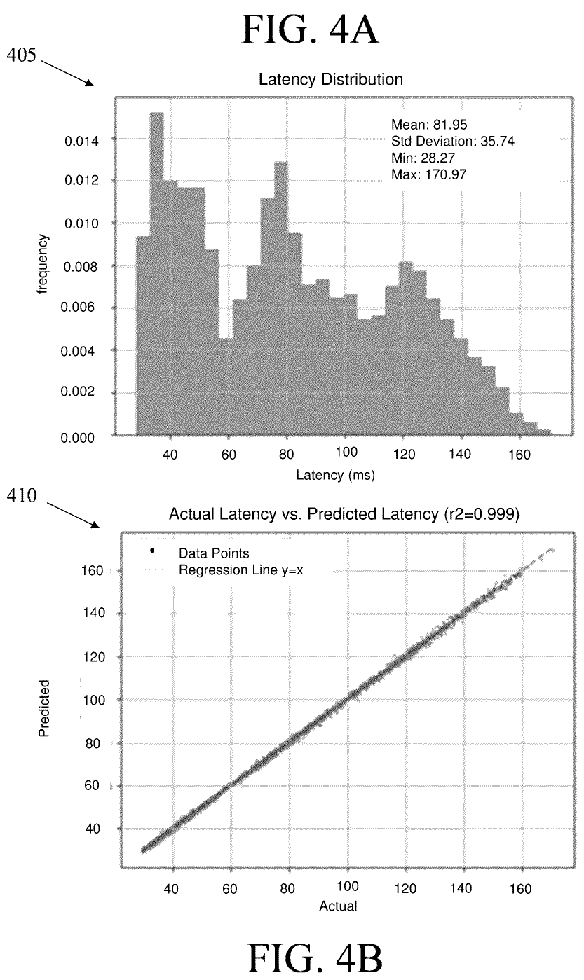

Additionally, FIG. 4A is a graph 405 illustrating the latency profiles on a Synaptics SR110 NPU chip for various randomly sampled object detection model architectures in the present NAS space. The lower latencies are typically on smaller image input size and vice versa. FIG. 4B is a graph 410 that indicates that the latency predictor (e.g., MLP network with two hidden layers) that was used to predict the model's latency on the Synaptics SR110 NPU chip is highly accurate. Graph 410 illustrates actual latency of the MCMP-NAS machine learning model running on the Synaptics SR110 NPU chip versus predicted latency for object detection using a simple two hidden layer MLP network. The MCMP-NAS machine learning model according to embodiments of the present invention is extremely accurate, as noted by the high R² score of 0.999.

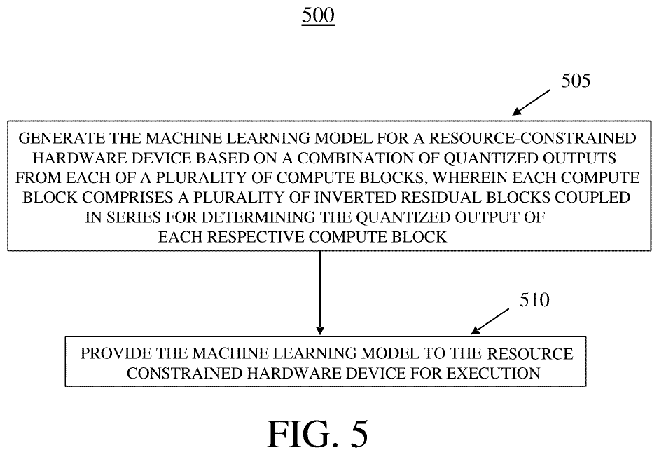

FIG. 5 is a flowchart of an example method 500 for hardware-aware joint optimization of machine learning model architecture and quantization. The method 500 can be performed by, for example, the system 100 or the computing device 700. At block 505, a machine learning model can be generated for a resource-constrained hardware device based on a combination of quantized outputs from each of a plurality of compute blocks. Each compute block can comprise a plurality of inverted residual blocks coupled in series for determining the quantized output of each respective compute block. At block 510, the machine learning model can be provided to the resource-constrained hardware device for execution.

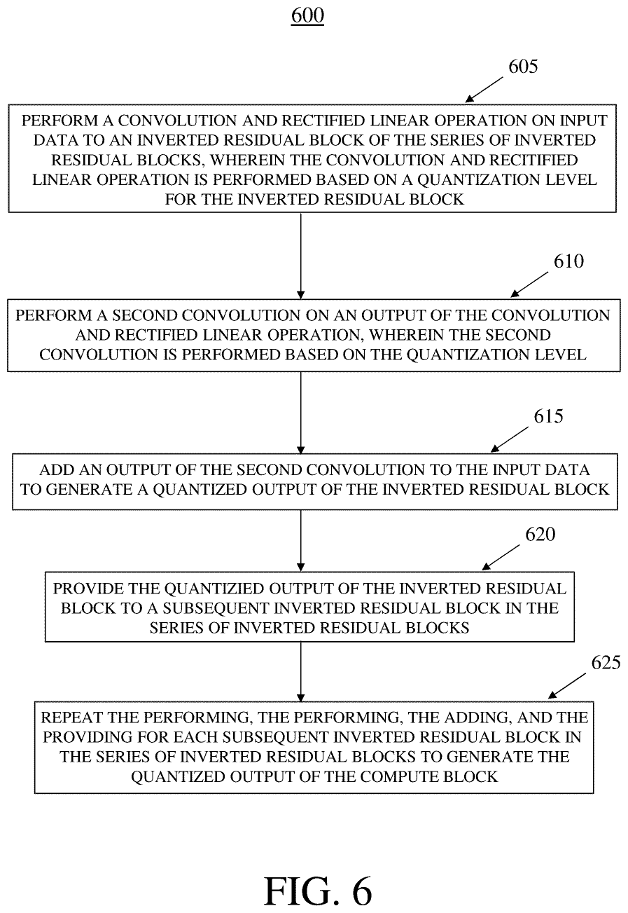

FIG. 6 is a flowchart of an example method 600 for determining the quantized output of each respective compute block, in accordance with block 505 of FIG. 5. At block 605, a convolution and rectified linear operation can be performed on input data to an inverted residual block of the series of inverted residual blocks. In embodiments, the convolution and rectified linear operation can be performed based on a quantization level for the inverted residual block. At block 610, a second convolution can be performed on an output of the convolution and rectified linear operation. In embodiments, the second convolution can be performed based on the quantization level. At block 615, an output of the second convolution can be added to the input data to generate a quantized output of the inverted residual block. At block 620, the quantized output of the inverted residual block can be provided to a subsequent inverted residual block in the series of inverted residual blocks. At block 625, the performing of block 605, the performing of block 610, the adding of block 615, and the providing of block 620 can be repeated for each subsequent inverted residual block in the series of inverted residual blocks to generate the quantized output of the compute block.

Embodiments of the present invention can improve computer processing, reduce latency, and lower memory requirements on resource-constrained hardware devices. For example, MCMP-NAS can achieve significantly lower latency for comparable performance as conventional state-of-the-art machine learning models on resource-constrained target hardware. Additionally, the mixed-precision NAS model of MCMP-NAS can achieve better performance than NAS optimized 8-bit and 4-bit quantized machine learning models with a considerably lower model size requirement on resource-constrained hardware devices.

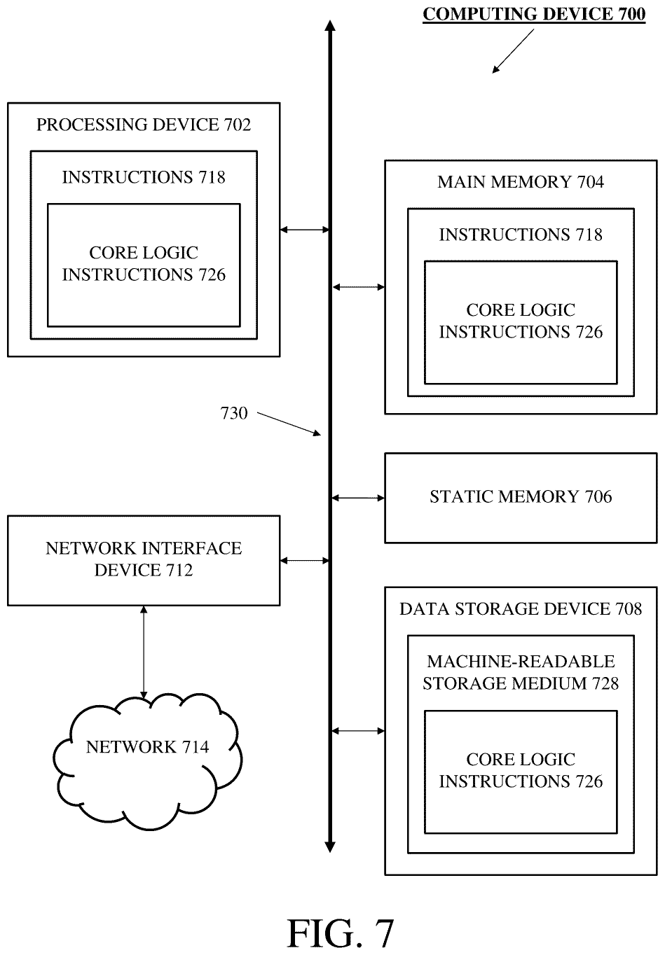

FIG. 7 is a block diagram of an example computing device 700 that may perform one or more of the operations described herein, in accordance with the present embodiments. The computing device 700 may be connected to other computing devices in a LAN, an intranet, an extranet, and/or the Internet. The computing device 700 may operate in the capacity of a server machine in client-server network environment or in the capacity of a client in a peer-to-peer network environment. The computing device 700 may be provided by a personal computer (PC), a set-top box (STB), a server, a network router, switch or bridge, or any machine capable of executing a set of instructions (sequential or otherwise) that specify actions to be taken by that machine. Further, while only a single computing device 700 is illustrated, the term “computing device” shall also be taken to include any collection of computing devices that individually or jointly execute a set (or multiple sets) of instructions to perform the methods discussed herein.

The example computing device 700 may include a computer processing device 702 (e.g., a general purpose processor, ASIC, etc.), a main memory 704, a static memory 706 (e.g., flash memory or the like), and a data storage device 708, which may communicate with each other via a bus 730. The computer processing device 702 may be provided by one or more general-purpose processing devices such as a microprocessor, central processing unit, or the like. In an illustrative example, computer processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 702 may also comprise one or more special-purpose processing devices, such as an application specific integrated circuit (ASIC), a field programmable gate array (FPGA), a digital signal processor (DSP), network processor, or the like. The computer processing device 702 may be configured to execute the operations described herein, in accordance with one or more aspects of the present disclosure, for performing the operations and steps discussed herein.

The computing device 700 may further include a network interface device 712, which may communicate with a network 714. The data storage device 708 may include a machine-readable storage medium 728 on which may be stored one or more sets of instructions, e.g., instructions for carrying out the operations described herein, in accordance with one or more aspects of the present disclosure. Instructions 718 implementing core logic instructions 726 may also reside, completely or at least partially, within main memory 704 and/or within computer processing device 702 during execution thereof by the computing device 700, main memory 704 and computer processing device 702 also constituting computer-readable media. The instructions may further be transmitted or received over the network 714 via the network interface device 712.

While machine-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, magnetic media, and the like.

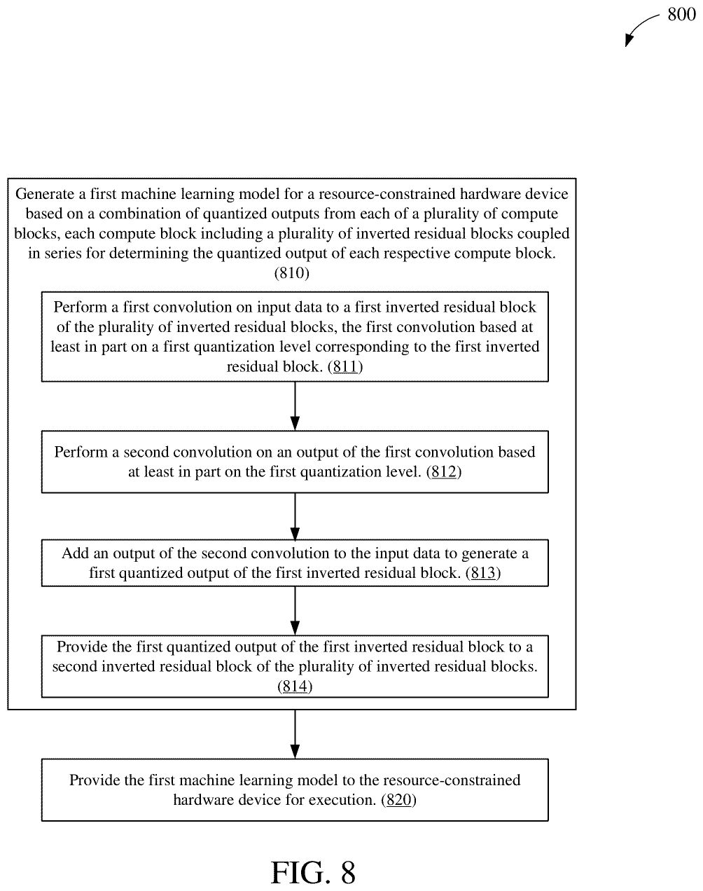

FIG. 8 is a flowchart of an example method 800 for hardware-aware joint optimization of machine learning model architecture and quantization, in accordance with some implementations. The method 800 can be performed by, for example, the system 100 or the computing device 700.

At block 810, the system 100 may generate a first machine learning model for a resource-constrained hardware device based on a combination of quantized outputs from each of a plurality of compute blocks, each compute block including a plurality of inverted residual blocks coupled in series for determining the quantized output of each respective compute block. Determining the quantized output of each respective compute block may include performing a first convolution on input data to a first inverted residual block of the plurality of inverted residual blocks, the first convolution based at least in part on a first quantization level corresponding to the first inverted residual block (811), performing a second convolution on an output of the first convolution based at least in part on the first quantization level (812), adding an output of the second convolution to the input data to generate a first quantized output of the first inverted residual block (813), and providing the first quantized output of the first inverted residual block to a second inverted residual block of the plurality of inverted residual blocks (814). At block 820, the system 100 may provide the first machine learning model to the resource-constrained hardware device for execution.

In some aspects, the first machine learning model includes a once-for-all (OFA) neural network generated based at least in part on a progressive shrinking algorithm, the OFA neural network including a plurality of sub-networks.

In some aspects, the plurality of inverted residual blocks includes a first number of inverted residual blocks, the first number selected based at least in part on an evolutionary algorithm configured to select a best performing sub-network of the plurality of sub-networks based at least in part on a constraint associated with the resource-constrained hardware device. In some aspects, the evolutionary algorithm is configured to select the best performing sub-network of the plurality of sub-networks based at least in part on one or more second machine learning models trained to predict performance of sub-networks of the plurality of sub-networks. In some aspects, the one or more second machine learning models are configured to predict an accuracy and a latency associated with one or more sub-networks of the plurality of sub-networks.

In some aspects, a kernel size associated with the first convolution and the second convolution is selected based at least in part on an evolutionary algorithm configured to select a best performing sub-network of the plurality of sub-networks based at least in part on a constraint associated with the resource-constrained hardware device.

In some aspects, a first channel expansion factor associated with the first inverted residual block is selected based at least in part on an evolutionary algorithm configured to select a best performing sub-network of the plurality of sub-networks based at least in part on a constraint associated with the resource-constrained hardware device.

In some aspects, an input resolution associated with the input data is selected based at least in part on an evolutionary algorithm configured to select a best performing sub-network of the plurality of sub-networks based at least in part on a constraint associated with the resource-constrained hardware device.

In some aspects, the first quantization level is selected based at least in part on one or more constraints associated with the resource-constrained hardware device, the one or more constraints including one or more of a latency constraint and a memory usage constraint.

In some aspects, the first convolution includes a first convolution and rectified linear operation based on the first quantization level.

In some aspects, determining the quantized output of each respective compute block further includes receiving the first quantized output as an input to the second inverted residual block, performing a third convolution on the first quantized output, the third convolution based at least in part on a second quantization level corresponding to the second inverted residual block, performing a fourth convolution on an output of the third convolution based at least in part on the second quantization level, adding an output of the fourth convolution to the first quantized output to generate a second quantized output of the second inverted residual block, and providing the second quantized output of the second inverted residual block to a third inverted residual block of the plurality of inverted residual blocks. In some aspects, the second quantization level is different from the first quantization level.

In some aspects, the plurality of compute blocks include at least a first compute block associated with the first quantization level and a second compute block associated with a second quantization level different from the first quantization level.

Embodiments of the subject matter and the operations described in this disclosure can be implemented in digital electronic circuitry, or in computer software, firmware, or hardware, including the structures disclosed in this disclosure and their structural equivalents, or in combinations of one or more of them. Embodiments of the subject matter described in this disclosure can be implemented as one or more computer programs, i.e., one or more modules of computer program instructions, encoded on computer storage medium for execution by, or to control the operation of, one or more data processors or data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processor or data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by one or more data processors or data processing apparatus on data stored on one or more computer-readable storage devices or received from other sources.

The terms “data processor” or “data processing apparatus” encompass all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor, a light emitting diode (LED) monitor, or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like. In addition, a computer can interact with a user by sending resources to and receiving resources from a device that is used by the user; for example, by sending web pages to a web browser on a user's client device in response to requests received from the web browser.

Embodiments of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by at least one data processor or data processing apparatus, cause the at least one data processor or data processing apparatus to perform the actions.

Reference throughout this disclosure to “one embodiment” or “an embodiment” means that a particular feature, structure, or characteristic described in connection with the embodiments included in at least one embodiment. Thus, the appearances of the phrase “in one embodiment” or “in an embodiment” in various places throughout this disclosure are not necessarily all referring to the same embodiment. In addition, the term “or” is intended to mean an inclusive “or” rather than an exclusive “or.”

While this disclosure contains many specific implementation details, these should not be construed as limitations on the scope of any inventions or of what may be claimed, but rather as descriptions of features specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations and/or logic flows are depicted in the drawings and/or described herein in a particular order, this should not be understood as requiring that such operations and/or logic flows be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

What is claimed is:

1. A method for hardware-aware joint optimization of machine learning model architecture and quantization, comprising:
generating a first machine learning model for a resource-constrained hardware device based on a combination of quantized outputs from each of a plurality of compute blocks, each compute block comprising a plurality of inverted residual blocks coupled in series for determining the quantized output of each respective compute block, wherein determining the quantized output of each respective compute block comprises:
performing a first convolution on input data to a first inverted residual block of the plurality of inverted residual blocks, the first convolution based at least in part on a first quantization level corresponding to the first inverted residual block;
performing a second convolution on an output of the first convolution based at least in part on the first quantization level;
adding an output of the second convolution to the input data to generate a first quantized output of the first inverted residual block; and
providing the first quantized output of the first inverted residual block to a second inverted residual block of the plurality of inverted residual blocks; and
providing the first machine learning model to the resource-constrained hardware device for execution.

2. The method of claim 1, wherein the first machine learning model comprises a once-for-all (OFA) neural network generated based at least in part on a progressive shrinking algorithm, the OFA neural network comprising a plurality of sub-networks.

3. The method of claim 2, wherein the plurality of inverted residual blocks comprises a first number of inverted residual blocks, the first number selected based at least in part on an evolutionary algorithm configured to select a best performing sub-network of the plurality of sub-networks based at least in part on a constraint associated with the resource-constrained hardware device.

4. The method of claim 3, wherein the evolutionary algorithm is configured to select the best performing sub-network of the plurality of sub-networks based at least in part on one or more second machine learning models trained to predict performance of sub-networks of the plurality of sub-networks.

5. The method of claim 4, wherein the one or more second machine learning models are configured to predict an accuracy and a latency associated with one or more sub-networks of the plurality of sub-networks.

6. The method of claim 2, wherein a kernel size associated with the first convolution and the second convolution is selected based at least in part on an evolutionary algorithm configured to select a best performing sub-network of the plurality of sub-networks based at least in part on a constraint associated with the resource-constrained hardware device.

7. The method of claim 2, wherein a first channel expansion factor associated with the first inverted residual block is selected based at least in part on an evolutionary algorithm configured to select a best performing sub-network of the plurality of sub-networks based at least in part on a constraint associated with the resource-constrained hardware device.

8. The method of claim 2, wherein an input resolution associated with the input data is selected based at least in part on an evolutionary algorithm configured to select a best performing sub-network of the plurality of sub-networks based at least in part on a constraint associated with the resource-constrained hardware device.

9. The method of claim 1, wherein the first quantization level is selected based at least in part on one or more constraints associated with the resource-constrained hardware device, the one or more constraints comprising one or more of a latency constraint and a memory usage constraint.

10. The method of claim 1, wherein the first convolution comprises a first convolution and rectified linear operation based on the first quantization level.

11. The method of claim 1, wherein determining the quantized output of each respective compute block further comprises:
receiving the first quantized output as an input to the second inverted residual block;
performing a third convolution on the first quantized output, the third convolution based at least in part on a second quantization level corresponding to the second inverted residual block;
performing a fourth convolution on an output of the third convolution based at least in part on the second quantization level;
adding an output of the fourth convolution to the first quantized output to generate a second quantized output of the second inverted residual block; and
providing the second quantized output of the second inverted residual block to a third inverted residual block of the plurality of inverted residual blocks.

12. The method of claim 11, wherein the second quantization level is different from the first quantization level.

13. The method of claim 1, wherein the plurality of compute blocks comprise at least a first compute block associated with the first quantization level and a second compute block associated with a second quantization level different from the first quantization level.

14. A system for hardware-aware joint optimization of machine learning model architecture and quantization, comprising:
at least one data processor and memory storing instructions, which, when executed by the at least one data processor, cause the at least one data processor to perform operations comprising:
generating a first machine learning model for a resource-constrained hardware device based on a combination of quantized outputs from each of a plurality of compute blocks, each compute block comprising a plurality of inverted residual blocks coupled in series for determining the quantized output of each respective compute block, wherein determining the quantized output of each respective compute block comprises:
performing a first convolution on input data to a first inverted residual block of the plurality of inverted residual blocks, the first convolution based at least in part on a first quantization level corresponding to the first inverted residual block;
performing a second convolution on an output of the first convolution based at least in part on the first quantization level;
adding an output of the second convolution to the input data to generate a first quantized output of the first inverted residual block; and
providing the first quantized output of the first inverted residual block to a second inverted residual block of the plurality of inverted residual blocks; and
providing the first machine learning model to the resource-constrained hardware device for execution.

15. The system of claim 14, wherein the first machine learning model comprises a once-for-all (OFA) neural network generated based at least in part on a progressive shrinking algorithm, the OFA neural network comprising a plurality of sub-networks.

16. The system of claim 15, wherein the plurality of inverted residual blocks comprises a first number of inverted residual blocks, the first number selected based at least in part on an evolutionary algorithm configured to select a best performing sub-network of the plurality of sub-networks based at least in part on a constraint associated with the resource-constrained hardware device.

17. The system of claim 16, wherein the evolutionary algorithm is configured to select the best performing sub-network of the plurality of sub-networks based at least in part on one or more second machine learning models trained to predict performance of sub-networks of the plurality of sub-networks.

18. The system of claim 17, wherein the one or more second machine learning models are configured to predict an accuracy and a latency associated with one or more sub-networks of the plurality of sub-networks.

19. The system of claim 14, wherein the plurality of compute blocks comprise at least a first compute block associated with the first quantization level and a second compute block associated with a second quantization level different from the first quantization level.

20. A non-transitory computer program product storing executable instructions, which, when executed by at least one data processor forming part of at least one computing system, implement operations comprising:
generating a first machine learning model for a resource-constrained hardware device based on a combination of quantized outputs from each of a plurality of compute blocks, each compute block comprising a plurality of inverted residual blocks coupled in series for determining the quantized output of each respective compute block, wherein determining the quantized output of each respective compute block comprises:
performing a first convolution on input data to a first inverted residual block of the plurality of inverted residual blocks, the first convolution based at least in part on a first quantization level corresponding to the first inverted residual block;
performing a second convolution on an output of the first convolution based at least in part on the first quantization level;
adding an output of the second convolution to the input data to generate a first quantized output of the first inverted residual block; and
providing the first quantized output of the first inverted residual block to a second inverted residual block of the plurality of inverted residual blocks; and
providing the first machine learning model to the resource-constrained hardware device for execution.
